(19) United States
(12) Patent Application Publication
(10) Pub. No.: US 2023/0124151 A1
(43) Pub. Date: Apr. 20, 2023

(54) SUPPORT FRAME FOR FACE MASK

(71) Applicant: Change How Ltd., Taichung City (TW)

(72) Inventor: Wei-Yu CHUANG, Taichung City (TW)

(21) Appl. No.: 17/501,632

(22) Filed: Oct. 14, 2021

(51) Int. Cl. A62B 9/04; A41D 13/11

(52) U.S. Cl. CPC A62B 9/04; A41D 13/1107

(57) ABSTRACT

A support frame for being used with a face mask includes a resilient transverse rod and a longitudinal extension longitudinally extending from a middle portion of the transverse rod and having a strip-shaped or belt-shaped pattern including two ends connected with the transverse rod in a way that a part of the transverse rod and the longitudinal extension combinedly define a hollow portion. Therefore, when a user wears the mask quipped with the support frame, the longitudinal extension and the transverse rod expand the mask outwardly, such that the mask won't be completely attached on the mouth and nose of the user, thereby effectively enhancing comfort of the user wearing the mask. Further, the support frame can be applied to any masks with a fold portion and can be reused. The support frame has a light and simplified structure having a small size to be conveniently stored.

### BACKGROUND OF THE INVENTION

### 1. Field of the Invention The present invention relates generally to an accessory for a face mask and more particularly, to a support frame adapted for being used with a face mask.

### 2. Description of the Related Art

The global pandemic of new coronavirus starts at the end of 2019. In order to avoid infection and the spread of the pandemic caused by direct contact or the clustering effect of close conversation, people must wear face masks when they go out on public transportation facilities or in public places or confined spaces. Face masks have become safe daily necessities for protecting people's life. However, because the face mask will be closely attached on the user's mouth and nose, after a long-term use of the face mask, it is easy to cause allergies to those with sensitive facial skin, and it is also easy to cause difficulty in breathing for children, elder, or ill people.

### SUMMARY OF THE INVENTION

The present invention has been accomplished in view of the above-noted circumstances. It is an objective of the present invention to provide a support frame adapted for being used with a face mask, which can enhance comfort of a user wearing the face mask.

To attain the above-mentioned objective, the present invention provides a support frame, which is adapted for being used with a face mask, comprising a transverse rod made of a resilient material, and a longitudinal extension longitudinally extending from a middle portion of the transverse rod and having a strip-shaped or belt-shaped pattern including two ends connected with the transverse rod in a way that a part of the transverse rod and the longitudinal extension combinedly define a hollow portion.

With the above-mentioned structural feature, when a user wears a face mask equipped with the support frame, the longitudinal extension and the transverse rod expand the face mask outwardly, such that the face mask won't be completely attached on the mouth and nose of the user, thereby effectively enhancing comfort of the user wearing the face mask. Further, the support frame can be suitably applied to any face masks with a fold portion and can be reused. Furthermore, the support frame has a light and simplified structure with a small size, such that it occupies less space and can be conveniently stored.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a support frame according to an embodiment of the present invention;

FIG. 2 is a schematic view showing that the support frame of the embodiment of the present invention is installed in a face mask; and

FIGS. 3 and 4 are schematic views showing a user wearing the face mask that is installed with the support frame of the embodiment of the present invention.

### DETAILED DESCRIPTION OF THE INVENTION

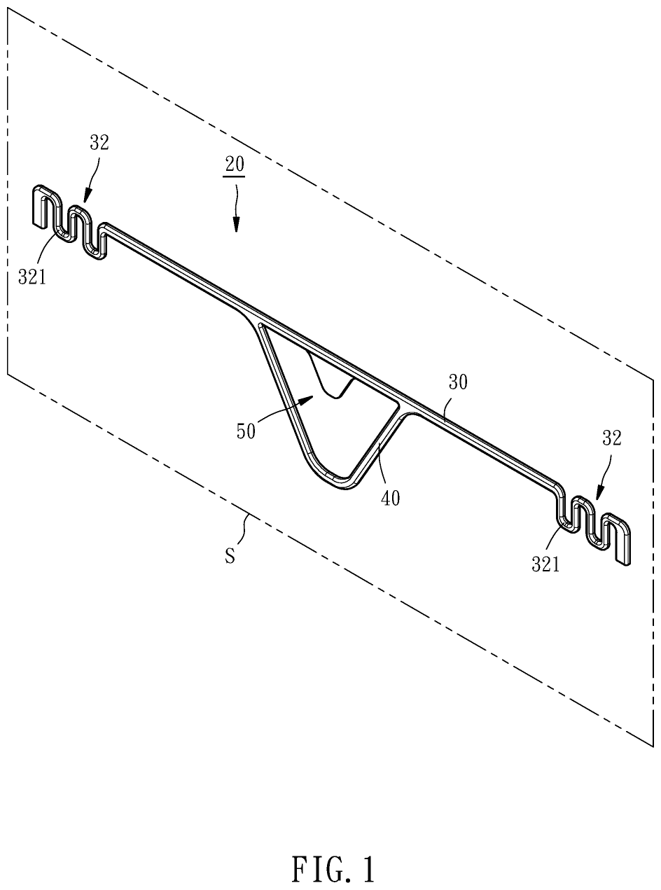

Hereunder a preferred embodiment will be detailedly described with accompanying drawings for illustrating technical features and structure of the present invention. As shown in FIGS. 1-4, a support frame 20, which is provided by a preferred embodiment of the present invention and adapted for being used with a face mask 10, is composed of a transverse rod 30 and a longitudinal extension 40.

The transverse rod 30 is provided at each of the two ends thereof with a telescopic portion 32 having a plurality of U-shaped or S-shaped curve sections 321 connected one after another. In the present embodiment, the telescopic portions 32 and remaining parts of the transverse rod 30 are monolithically formed by a resilient material, such that the transverse rod 30 including the telescopic portions 2 can be bent after receiving an external force. In addition to deformation of bending, the two telescopic portions 32 can also change their length along the extending direction of the transverse rod 30 after receiving an external force. Further, the cross-sections of the transverse rod 30 including the telescopic portions 32 are shaped like a flat rectangle. In another feasible embodiment, the shape and structure of the transverse rod 30 including the telescopic portions 32 can be modified according to actual requirement.

The longitudinal extension 40 longitudinally extends outwardly from a middle portion of the transverse rod 30 having the extending direction in a transversal direction. The longitudinal extension 40 has a strip-like V-shaped pattern having two ends connected with the transverse rod 30 in a such way that a part of the transverse rod 30 and the longitudinal extension 40 combinedly define a hollow portion 50 of triangular shape therebetween. In another embodiment, the longitudinal extension 40 may be configured having a belt-shaped pattern or other shape. Further, the longitudinal extension 40 and the transverse rod 30 can be monolithically formed by a resilient material, and the cross-sections of the longitudinal extension 40 are shaped like a flat rectangle. In the present embodiment, the longitudinal extension 40 extends downwardly from the transverse rod 30; however; the extending direction of the longitudinal extension 40 is not limited thereto. For example, the longitudinal extension 40 may be configured as being extended from the transverse rod 30 upwardly. Moreover, the hollow portion 50 may be configured as having a rectangular shape, semicircular shape, polygonal shape, or irregular shape.

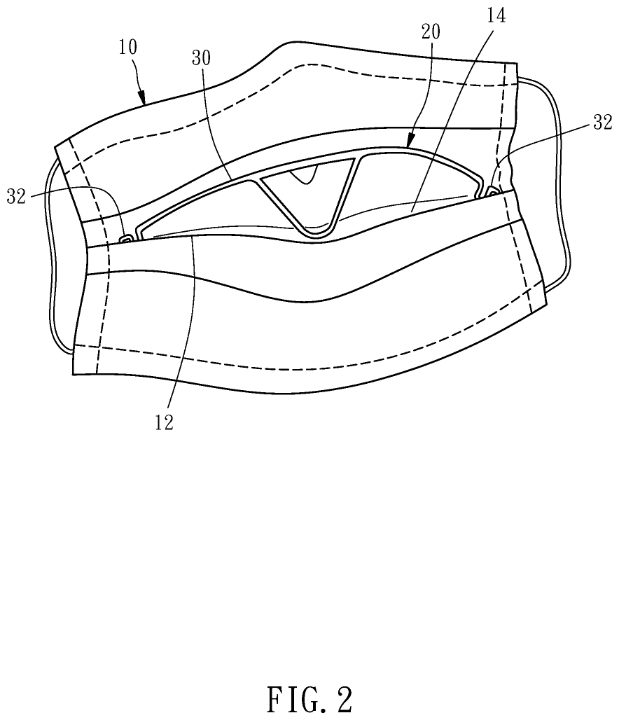

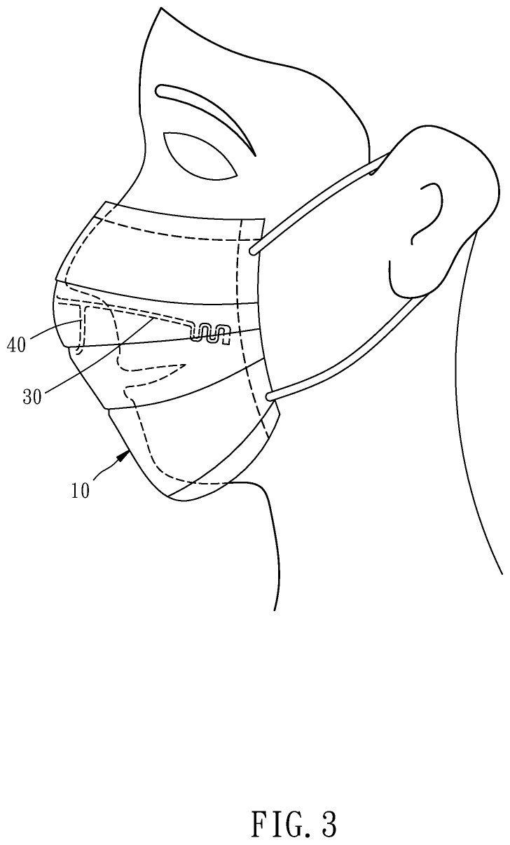

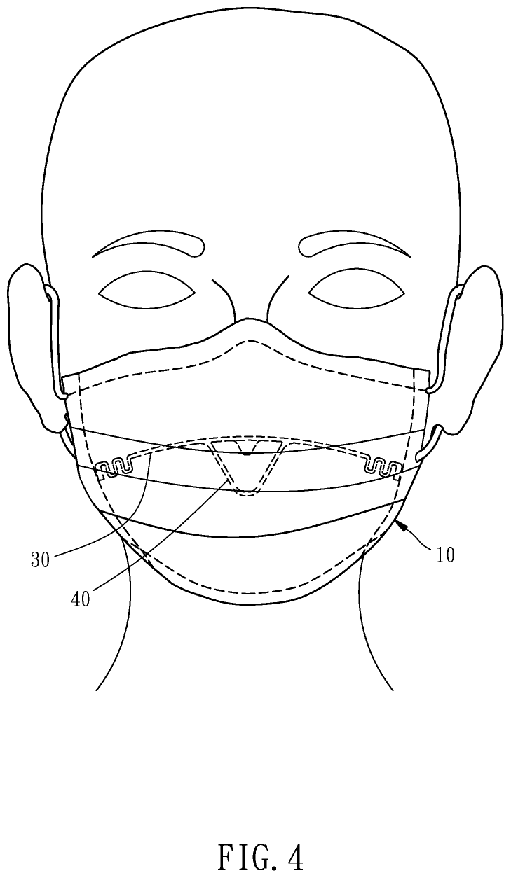

As shown in FIG. 1, when the support frame 20 receives no external force to deform, the transverse rod 30 and the longitudinal extension 40 are coplanarly located at an imaginary plane S. As shown in FIG. 2, when the support frame 20 is installed in the face mask 10, the two ends of the transverse rod 30, i.e., the two telescopic portions 32, are inserted into an accommodation 14 formed by one of fold portions 12 of the face mask 10. Because the length of the transverse rod 30 is designed as being greater than the length of the accommodation 14, the transverse rod 30 will be forced to deform to become an arc shape, and at the same time the U-shaped curve sections 321 will slightly deform due to the grounds that they are abutted against the fold portion 12. As a result, as shown in FIGS. 3 and 4, when a user wears the face mask 10 equipped with the support frame 20, the longitudinal extension 40 and the transverse rod 30 will expand the face mask 10 outwardly, such that the face mask 10 won't be completely attached on the mouth and nose of the user and the hollow portion 50 can increase the expanding area of the face mask 10. Therefore, the support frame 20 can minimize the possibility of allergies to the facial skin of the user and avoid the difficulty in breathing due to long-term use of the face mask 10, thereby effectively enhancing comfort of the user wearing the face mask 10. Further, the support frame 20 has a light weight with small size, such that when a user wears a face mask 10 equipped with the support frame 20, a user can hardly feel the weight of the support frame 20, thereby causing no burden in wearing. Furthermore, the support frame 20 can be suitably applied to any face masks with a fold portion and can be reused in a new face mask after the old one is disposed. Moreover, the support frame 20 has a flat shape, which occupies less space and can be conveniently taken out when it is stored in a bag or a pocket.

In practice, because the conventional face mask 10 has a plurality of fold portions 12, a user can insert the two ends of the transverse rod 30 into the accommodation 14 formed by any of the fold portions 12 of the face mask 10. As shown in FIG. 3, after the support frame 20 is installed in the face mask 10, the hollow portion 50 is located between the mouth and the nose of the user without direct contact with the mouth and the nose of the user, leaving a space between the face mask 10 and a portion of the face of the user. This is the optimal position arrangement of the support frame 20 in a face mask; however, the installation position of the support frame 20 is not limited to the one shown in FIGS. 3 and 4.

The support frame 20 not only can be used with an adult face mask but also a children or baby face mask. Because the length of children or baby face mask is less than that of the adult face mask, the telescopic portions 32 at two ends of the transverse rod 30 can be cut off with a certain length in advance, and then the trimmed support frame 20 can be installed in the fold portion of the children or baby face mask, achieving the effects of the present invention.

Based on the technical features of the present invention, various modifications to the support frame may be made. For example, in another feasible embodiment, the two ends of the transverse rod 30 may be provided with no two telescopic portions 32. Instead, the two ends of the transverse rod 30 may be configured as having a hook shape or other shape, which can be inserted into the fold portion 12 of the face mask 10. Further, the two telescopic portions 32 can be clamped on the top edge of the fold portion 12 of the face mask 10 by means of their U-shaped structure that is like a paper clip. Furthermore, the support frame 20 may be configured as being an arc shape or other 3D shape without receiving any external force to deform. That is, the transverse rod 30 and the longitudinal extension 40 are configured not being coplanarly located at the imaginary plane S when the support frame 20 receives no external force to deform. Such variations are not to be regarded as a departure from the spirit and scope of the invention, and all such modifications as would be obvious to one skilled in the art are intended to be included within the scope of the following claims.

What is claimed is:

1. A support frame for being used with a face mask, the support frame comprising:
a transverse rod made of a resilient material; and
a longitudinal extension longitudinally extending from a middle portion of the transverse rod and having a strip-shaped or belt-shaped pattern including two ends connected with the transverse rod in a way that a part of the transverse rod and the longitudinal extension combinedly define a hollow portion therebetween.

2. The support frame as claimed in claim 1, wherein the transverse rod comprises two ends; each of the two ends of the transverse rod is provided with a resilient telescopic portion.

3. The support frame as claimed in claim 2, wherein each of the resilient telescopic portions is provided with at least one U-shaped curve section.

4. The support frame as claimed in claim 1, wherein the longitudinal extension extends downwardly from the transverse rod.

5. The support frame as claimed in claim 1, wherein the hollow portion has a triangular, rectangular or semicircular shape.

6. The support frame as claimed in claim 1, wherein the transverse rod and the longitudinal extension are coplanarly located at an imaginary plane when the support frame receives no external force to deform.

7. The support frame as claimed in claim 6, wherein the two ends of the transverse rod are inserted into a fold portion of the face mask such that the transverse rod is deformed to an arc shape.
